(19) United States
(12) Patent Application Publication
(10) Pub. No.: US 2003/0134662 A1
(43) Pub. Date: Jul. 17, 2003

(54) Clear reject message for call clearing and mobile resource assignment with holding call

(75) Inventors: Shamik Shah, Plano, TX (US); Yi Chun Chou, Golden, CO (US)

Correspondence Address: NOVAKOV DAVIS & MUNCK, A PROFESSIONAL CORPORATION, 900 THREE GALLERIA TOWER, 13155 NOEL ROAD, DALLAS, TX, 75240, US

(73) Assignee: SAMSUNG ELECTRONICS CO., LTD., Suwon-city (KR)

(21) Appl. No.: 10/035,354

(22) Filed: Dec. 28, 2001

(51) Int. Cl. H04M 1/00

(52) U.S. Cl. 455/560; 455/445; 455/422

(57) ABSTRACT

A new Clear Reject message (or, equivalently, a new cause value indicating “Call on Hold” for the Clear Command) is defined for IS-2001 wireless communications to prevent resource deallocation prior to re-paging of a mobile station terminating connections with a call on hold. In response to receiving the new message from a mobile switching center, the serving base station maintains resource allocations for the mobile station and notifies the mobile station of the holding call, causing a ring tone to sound at the mobile station. State transition and paging channel monitoring by the mobile station, use of paging resources by the mobile switching center, and resource tear-down and reassignment by the base station are all avoided.

### TECHNICAL FIELD OF THE INVENTION

The present invention is directed, in general, to call waiting in wireless voice communication systems and, more specifically, to handling a holding call when the user inadvertently presses “END” to terminate an active call.

### BACKGROUND OF THE INVENTION

In wireless voice communications systems, when a mobile station for a wireless subscriber having call waiting is in a conversation with a first call party, during which a second call party attempts to establish a connection to the mobile station, the mobile station will receive a call waiting notification from the base station serving that mobile station to indicate the incoming call on the other line. The mobile station sends a flash with information message to the base station (e.g., by pressing a “Talk” or “Connect” button) to place the first call party on hold while connecting to the second call party.

Under normal circumstances, the mobile station user would press “Talk” to toggle between the two parties to, for example, resume the connection to the first call party after talking to the second call party. Often, however, the user will inadvertently press the “End” button upon finishing the conversation with the second call party in order to disconnect that call, which also terminates the connection to the first call party.

Interoperability Standard (IS) 2001 specifies that when a mobile station releases an active call after receiving a call waiting notification and while a call is waiting, the active call is cleared using normal call release procedures and the waiting call is cleared or terminated using normal mobile call-termination procedures. Active call clearing initiated by the mobile station begins with the mobile station sending a release order to the serving base station and setting a timer (e.g., 2 seconds) to receive an acknowledgement from the base station. The base station then sends a clear request to the mobile switching center which, in turn, sends a clear command to the base station to indicate resource release. After receiving the clear command, the base station sends a release order to the mobile station, and then a clear complete message to the mobile switching center to indicate that the resources have been cleared and are available for other calls.

Normal mobile call termination of the holding call after inadvertent disconnection by the user begins with the mobile switching center detecting a holding call for the mobile station and sending a paging request to the base station. The base station sends a page message to the mobile station and awaits a page response message from the mobile station. After receiving the page response, the base station sends a complete layer 3 information paging response message to the mobile switching center, which sends an assignment request to the base station. The base station sets up resources and sends a channel assignment message to the mobile station. After service has been connected, the base station sends an assignment complete message to the mobile switching center while sending an alert with information message to the mobile station to generate a ring tone at the mobile station. After the user presses “Talk”, a connect order is sent to the base station, which then sends a connect message to the mobile switching center to indicate connection.

The process described above is inefficient in that the mobile station's resources are idle during the waiting period for receiving a release order back from the base station, and then must traverse the mobile station transition states to reacquire the system and monitor the paging channel. Moreover, the mobile switching center is required to go through the normal mobile termination procedures to page the mobile station, consuming resources on the paging and access channels, and the base station must tear down all assigned resources and reassign resources after receiving an assignment request from the mobile switching center.

There is, therefore, a need in the art for improving the call waiting and call re-page processes for case where a mobile station releases an active call while a call is waiting after receiving a call waiting notification.

### SUMMARY OF THE INVENTION

To address the above-discussed deficiencies of the prior art, it is a primary object of the present invention to provide, for use in a wireless communications system, a new Clear Reject message (or, equivalently, a new cause value indicating “Call on Hold” for the Clear Command) which is defined for IS-2001 wireless communications to prevent resource deallocation prior to re-paging of a mobile station terminating connections with a call on hold. In response to receiving the new message from a mobile switching center, the serving base station maintains resource allocations for the mobile station and notifies the mobile station of the holding call, causing a ring tone to sound at the mobile station. State transition and paging channel monitoring by the mobile station, use of paging resources by the mobile switching center, and resource tear-down and reassignment by the base station are all avoided.

The foregoing has outlined rather broadly the features and technical advantages of the present invention so that those skilled in the art may better understand the detailed description of the invention that follows. Additional features and advantages of the invention will be described herein that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a wireless communications system implementing a Clear Reject message according to one embodiment of the present invention;

FIG. 2 is a call flow diagram for implementing a Clear Reject message according to one embodiment of the present invention;

FIG. 3 is a high level flowchart for a base station call handling process involving a Clear Reject message according to one embodiment of the present invention;

FIG. 4 is a high level flowchart for a mobile switching center call handling process involving a Clear Reject message according to one embodiment of the present invention;

FIG. 5 is a call flow diagram for implementing an alternative Clear Command message according to one embodiment of the present invention;

FIG. 6 is a high level flowchart for a base station call handling process involving an alternative Clear Command message according to one embodiment of the present invention; and

FIG. 7 is a high level flowchart for a mobile switching center call handling process involving an alternative Clear Command message according to one embodiment of the present invention.

### DETAILED DESCRIPTION OF THE INVENTION

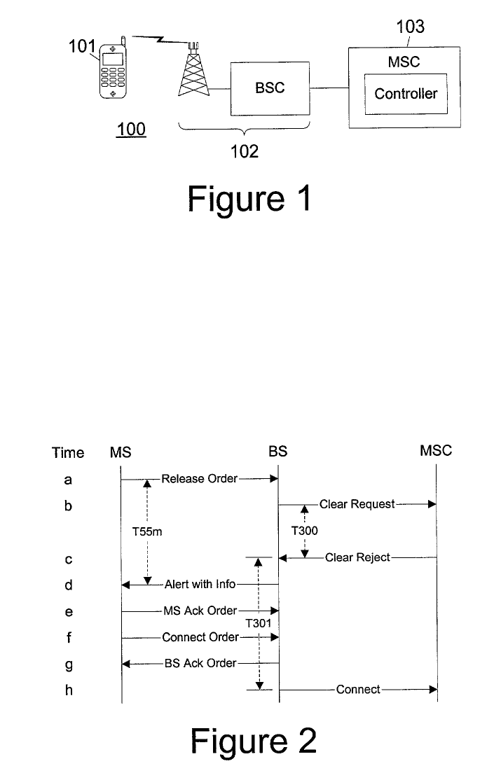

FIGS. 1 through 7, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a wireless communications system implementing a Clear Reject message according to one embodiment of the present invention. Wireless communications system 100 depicted in FIG. 1 is a portion of a wireless communications network and includes a mobile station (MS) 101 adapted for wireless communications with a base station 102, which includes a base station controller (BSC). Base station 102 provides wireless communications resources for calls involving mobile station 101 under the control of mobile switching center (MSC) 103. The wireless communications network including system 100 may include other base stations and mobile stations as well as other resources such as connections to landline communications systems and/or other wireless networks.

Those skilled in the art will recognize that the complete structure and operation of a wireless communications network is not depicted or described. The present invention may be implemented by adapting a conventional wireless communications system, and only so much of the structure and operation of a wireless communications system as is unique to the present invention or necessary for an understanding of the present invention is depicted or described. Regardless of the particular details of construction and operation, however, wireless communications system 100 implements a Clear Reject message at the A interface (between the base station 102 and the mobile switching center 103) as described below for situations in which a mobile station releases an active call while a call is waiting after receiving a call waiting notification.

FIG. 2 is a call flow diagram for implementing a Clear Reject message according to one embodiment of the present invention. Illustrated in FIG. 2 are wireless communications messages among the mobile station (MS) 101, the base station (BS) 102, and the mobile switching center (MSC) 103 within wireless communications system 100 depicted in FIG. 1. The call flow depicted begins at time a with a release order from the mobile station in accordance with the normal call clearing procedures employed by the mobile station to clear the active call while a call is waiting after receiving a call waiting notification in accordance with IS-2001. Transmission of the release order begins a timer T55m defined to have a maximum value of 2 seconds.

Still conforming to IS-2001 normal call clearing procedures, the base station receiving the release order from the mobile station transmits a Clear Request at time b to the mobile switching center to initiate the call clearing transaction, and starts timer T300 defined to have a default value of 1.5 seconds. In the present invention, rather than a Clear Command, the mobile switching center responds to the base station's Clear Request at time c with a Clear Reject message to indicate that a call is on hold for the mobile station, and starts a timer T301 defined to have a default value of 30 seconds. The base station stops timer T300 upon receiving the Clear Reject message.

In response to the Clear Reject message from the mobile switching station, the base station would not release resources dedicated for use by the mobile station as the base station would in response to a Clear Command message from the mobile switching station. Instead, the base station transmits an Alert with Information message at time d to the mobile station over the forward traffic channel to alert the mobile of the call on hold and to cause a ring tone to sound at the mobile station. The mobile station stops timer T55m upon receiving the Alert with Information message.

To acknowledge reception of the alert with information message from the base station, the mobile station transmits a mobile station acknowledgement (MS Ack) order at time e to the base station on the reverse traffic channel. When the user presses the “Talk” button at the mobile station to “answer” (i.e., reconnect to) the call on hold, the mobile station transmits a Connect Order with acknowledgement required at time f over the reverse traffic channel to the base station. The base station then transmits a base station Acknowledgement order at time g over the forward traffic channel to acknowledge the connect order, and then a Connect message at time h to the mobile switching center to indicate that the holding call has been answered at the mobile station. The mobile switching center stops timer T301 when the Connect message is received from the base station.

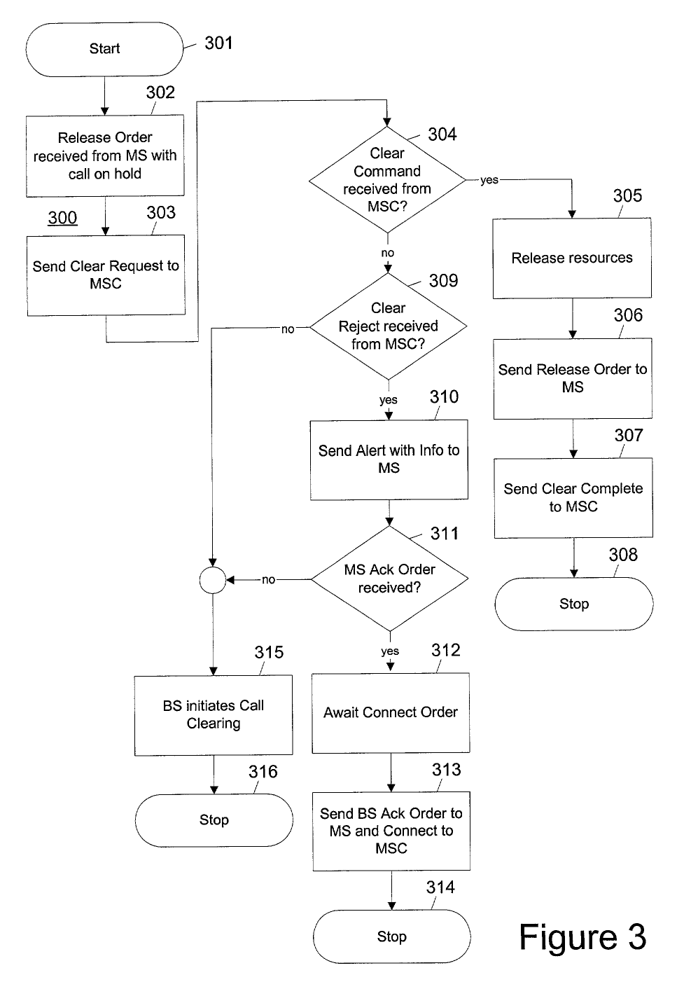

FIG. 3 is a high level flowchart for a base station call handling process involving a Clear Reject message according to one embodiment of the present invention. The process 300, performed by base station 102 within the wireless communications system 100 depicted in FIG. 1, starts (step 301) when the mobile station is in conversion state and has the call-waiting feature active. A Release order is received from the mobile station (step 302), which has a call on hold. In response to receiving the Release order, the base station sends a Clear Request to the mobile switching center (step 303).

If a Clear Command is received from the mobile switching center (step 304), the base station releases resources dedicated to the mobile station (step 305), sends a Release order to the mobile station (step 306), and sends a Clear Complete to the mobile switching center (step 307) before stopping (step 308).

If a Clear Reject is received from the mobile switching center instead of a Clear Command (step 309), the base station transmits an Alert with Information to the mobile station (step 310). If a mobile station Acknowledgement order is then received from the mobile station (step 311), the base station awaits reception of a Connect order from the mobile station (step 312) and, upon receipt of the Connect order from the mobile station, transmits a base station Acknowledgement order to the mobile station and a Connect message to the mobile switching center (step 313) before stopping (step 314).

If neither a Clear Command nor a Clear Reject is received by the base station from the mobile switching center (steps 304 and 309), or if no mobile station Acknowledgement order is received from the mobile station in response to the Alert with Information message transmitted to the mobile station (step 311), the base station initiates call clearing (step 315) in accordance with existing procedures before stopping (step 316).

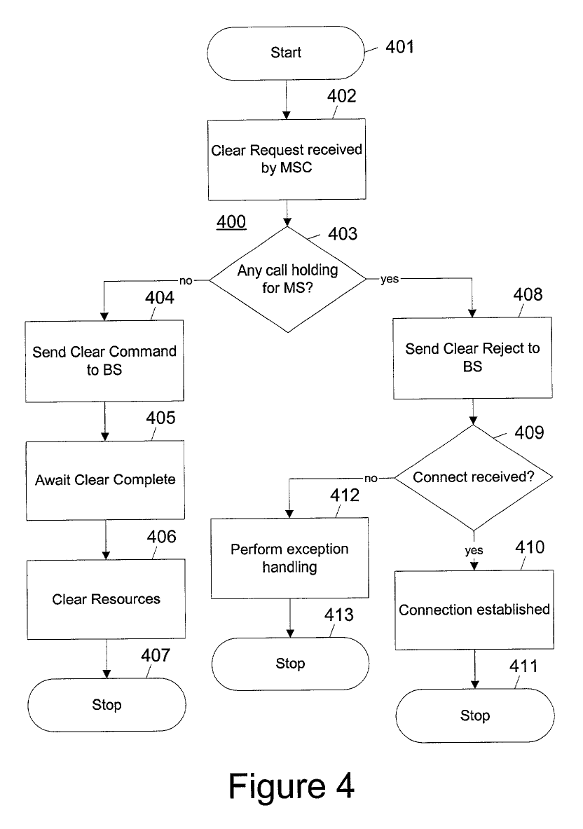

FIG. 4 is a high level flowchart for a mobile switching center call handling process involving a Clear Reject message according to one embodiment of the present invention. The process 400, performed by mobile switching center 103 within the wireless communications system 100 depicted in FIG. 1, starts (step 401) when a mobile station in on a traffic channel and the mobile switching center has another call on hold for that mobile station.

When the user inadvertently presses “End” rather than toggling between calls by pressing “Talk”, the mobile switching center receives a Clear Request from the base station serving the mobile station (step 402). If no call is holding for that mobile station (step 403), the mobile switching center sends a Clear Command to the serving base station (step 404), awaits a Clear Complete from the serving base station (step 405), and, upon receiving the Clear Complete, clears resources dedicated to the mobile station (step 406) before stopping (step 407).

If, on the other hand, a call is holding for the mobile station triggering the Clear Request (step 403), the mobile switching center transmits a Clear Reject to the serving base station (step 408). If a connect message is subsequently received by the mobile switching center from the serving base station (step 409), a connection between the holding call and the mobile station is established by the mobile switching center (step 410) before stopping (step 411). If no Connect message is received by the mobile switching center from the serving base station within the period for timer T301 (step 409), the mobile switching center performs exception handling (step 412) before stopping (step 413).

The Clear Reject message described above in connection with FIGS. 1 through 4 is a Base Station Management Application Part (BSMAP) message transmitted from the mobile switching center to the base station in order to request that the base station NOT clear resources designated for the mobile station and inform the mobile station that a call for that mobile station is on hold. Table I tabulates the basic structure of such a Clear Reject message implemented in conformance to IS-2001:

TABLE I

| | IS-2001 | | |
|---|---|---|---|
| | Section | Element | |
| Information Element | Reference | Direction | Type |
| Message Type | New | MSC → BS | Mandatory |
| Cause Value | New | MSC → BS | Mandatory |
| Signal | 6.2.2.50 | MSC → BS | Optional |
| Calling Party ASCII | 6.2.2.37 | MSC → BS | Optional |
| Number | | | |

The message type is mandatory in order to identify the message, with a hex value of 23H preferred to identify the message type as “Clear Reject”. The cause value is also mandatory in order to alert the base station as to the reason for rejecting the clear request. A new cause of “Call on Hold” is preferably added under class 000 or 001 as a normal event, with a hex value of 15H to indicate “Call on Hold”. Signal is an optional element since the base station may send default tones to the mobile station without any mobile switching center indication. Calling Party ASCII Number is also an optional element required only to support supplementary services, Calling Number ID Presentation/Calling Number ID Restriction. Called Party Number, CIC, Channel Type, Service Option, and Encryption Information are not seen as necessary since the base station has already designated resource to the mobile station and should therefore be tracking that information.

Table II tabulates a bitmap layout of a clear reject message implemented for compatibility with IS-2001, with differences identified in boldface italics:

TABLE II

| | | | | | | | | |
|---|---|---|---|---|---|---|---|---|
| 7 | 6 | 5 | 4 | 3 | 2 | 1 | 0 | Octet |

| BSMAP Header: Message Discrimination = [00H] | | | | 1 |
|---|---|---|---|---|
| Length Indicator (LI) = <Variable> | | | | 2 |
| Message Type = [23H] | | | | 1 |
| Cause: A1 Element Identifier = [04H] | | | | 1 |
| Length = [01H] | | | | 2 |
| ext = [0] | Cause Value = | | | 3 |
| | 07H (OAM&P intervention) | | | |
| | 09H (Call Processing) | | | |
| | 0AH (reversion to old channel) | | | |
| | 0BH (handoff successful) | | | |
| | 20H (equipment failure) | | | |
| | 60H (protocol error between BS and MSC) | | | |
| | 78H (Do not notify MS) | | | |
| | 15H (Call on hold) | | | |
| | Signal: A1 Element Identifier = [34H] | | | 1 |
| Signal Value = | | | | 2 |
| 40H (normal) | | | | |
| 41H (inter-group) | | | | |
| 42H (special/priority) | | | | |
| 44H (ping ring) | | | | |
| 4FH (alerting off) | | | | |
| 81H (long) | | | | |
| 82H (short - short) | | | | |
| 83H (short - short - long) | | | | |
| 84H (short - short - 2) | | | | |
| 85H (short - long - short) | | | | |
| 86H (short-short - short - short) | | | | |
| 87H (PBX long) | | | | |
| 88H (PBX short - short) | | | | |
| 89H (PBX short - short - long) | | | | |
| 8AH (PBX short - long - short) | | | | |
| 82H (PBX short - short-short - short) | | | | |
| Reserved = [000000] | | | Alert pitch = | 3 |
| | | | [00, 01, 10] | |
| | | | (med. high, low) | |
| Calling Party ASCII Number: A1 Element Identifier = | | | | 1 |
| [4BH] | | | | |
| Length = [01H − FFH] | | | | 2 |
| ext = [0] | Type of Number = [as in | | Numbering Plan | 3 |
| | T1.607 Sec. 4.5.9 except | | Identification = | |
| | 5 and 7] | | [as in T1.607 Sec | |
| | | | 4.5.9] | |
| ext = [1] | Presentation | Reserved = | Screening | 4 |
| | Indicator = | [000] | Indicator = [as in | |
| | [as in | | T1.607 Sec 4.5.9] | |
| | T1.607 Sec | | | |
| | 4.5.9] | | | |

| | |
|---|---|
| Printable ASCII Character 1 = [00H − FFH] | 5 |
| Printable ASCII Character 2 | 6 |
| ... | ... |
| Printable ASCII Character n | n |

Considering possible implementation issues for a new message, one alternative achieving a similar functionality entails including a new cause value of 15H to indicate “Call on Hold” in the existing clear command message.

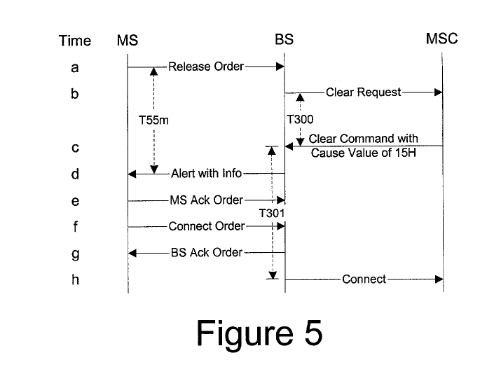

FIG. 5 is a call flow diagram for implementing an alternative Clear Command message according to one embodiment of the present invention. As with FIG. 2, FIG. 5 illustrates wireless communications messages among the mobile station (MS) 101, the base station (BS) 102, and the mobile switching center (MSC) 103 within wireless communications system 100 depicted in FIG. 1, with the call flow depicted beginning at time a with a Release Order from the mobile station in accordance IS-2001. Transmission of the Release Order begins a timer T55m defined to have a maximum value of 2 seconds.

Still conforming to IS-2001 normal call clearing procedures, the base station receiving the Release Order from the mobile station transmits a Clear Request at time b to the mobile switching center to initiate the call clearing transaction, and starts timer T300 defined to have a default value of 1.5 seconds. In this embodiment of the present invention, the mobile switching center responds to the base station's Clear Request at time c with a Clear Command message having a cause value of 15H to indicate that a call is on hold for the mobile station, and starts a timer T301 defined to have a default value of 30 seconds. The base station stops timer T300 upon receiving the Clear Command message.

In response to the [15H] Clear Command message from the mobile switching station, the base station does not release resources dedicated for use by the mobile station, but instead the base station transmits an Alert with Information message at time d to the mobile station over the forward traffic channel to alert the mobile of the call on hold and to cause a ring tone to sound at the mobile station. The mobile station stops timer T55m upon receiving the alert with information message.

To acknowledge reception of the alert with information message from the base station, the mobile station transmits a mobile station Acknowledgement Order at time e to the base station on the reverse traffic channel. When the user presses the “Talk” button at the mobile station to “answer” (i.e., reconnect to) the call on hold, the mobile station transmits a Connect Order with acknowledgement required at time f over the reverse traffic channel to the base station. The base station then transmits a base station Acknowledgement Order at time g over the forward traffic channel to acknowledge the Connect Order, and then a Connect message at time h to the mobile switching center to indicate that the holding call has been answered at the mobile station. The mobile switching center stops timer T301 when the Connect message is received from the base station.

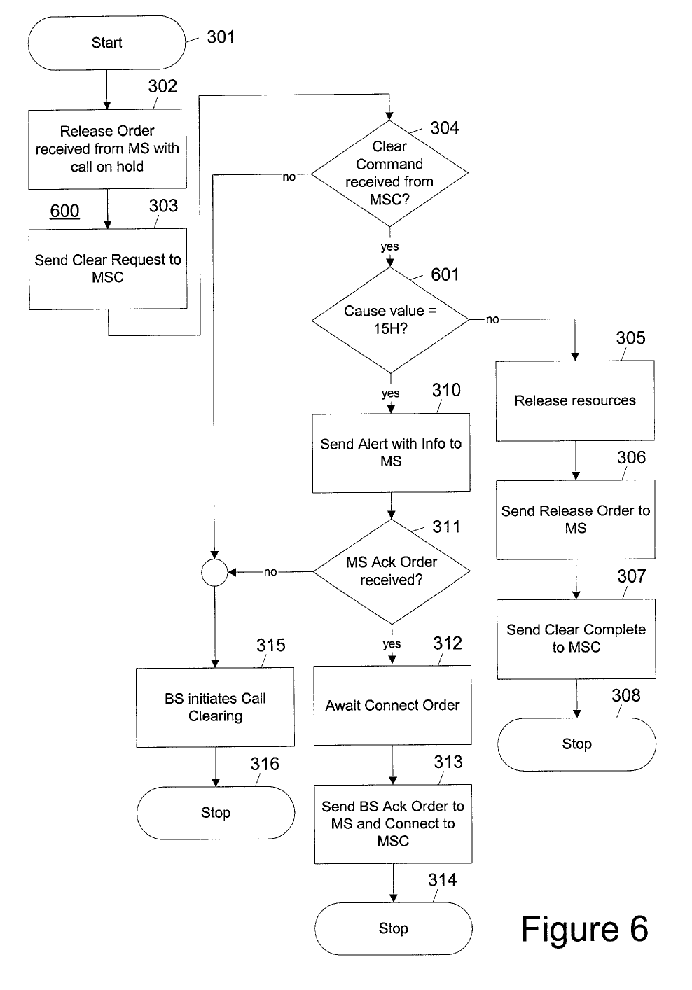

FIG. 6 is a high level flowchart for a base station call handling process involving an alternative Clear Command message according to one embodiment of the present invention. The process 600 is largely similar to process 300 depicted in FIG. 3, except that a determination is made as to whether the cause value of a received Clear Command is 15H or a similar predetermined value (step 601) rather than a determination of whether a clear Reject message was received (step 309). The branching from steps 304 and new step 601 also differs slightly, reflecting the use of the Clear Command with a newly defined cause value rather than a new Clear Reject message.

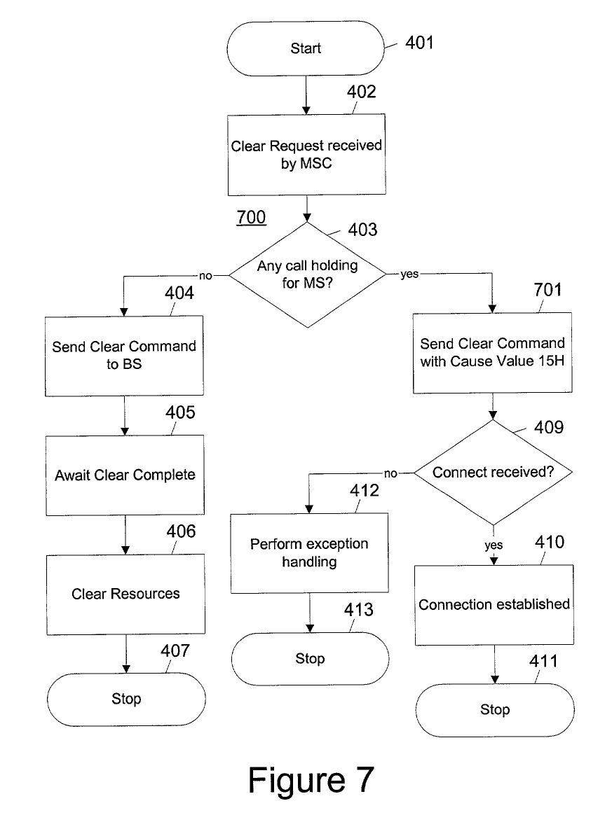

FIG. 7 is a high level flowchart for a mobile switching center call handling process involving an alternative Clear Command message according to one embodiment of the present invention. Process 700 is essentially identical to process 400 depicted in FIG. 4, except that a Clear Command with cause value 15H is transmitted to the base station (step 701) rather than a Clear Reject message (step 408).

The present invention minimizes the time and resources required for the re-paging process used when a mobile station with the call waiting feature active inadvertently terminates (rather than toggles) connections and leaves a call on hold after a call waiting notification. The present invention may be achieved through either implementation of a new Clear Reject message, or reuse of the Clear Command with a newly defined cause value specifying “Call on Hold”. In either case, however, resources are not released by the base station (which typically cannot independently determine whether a call is holding for a mobile station terminating connections), but instead maintains the resource allocation and notifies the mobile station of the holding call.

It is important to note that while the present invention has been described in the context of a fully functional communications device or system, those skilled in the art will appreciate that the mechanism of the present invention is capable of being implemented and distributed in the form of a computer usable medium of instructions in a variety of forms, and that the present invention applies equally regardless of the particular type of signal bearing medium is used to carry out the distribution. Examples of suitable computer usable mediums include: nonvolatile, hard-coded or programmable type mediums such as read only memories (ROMs) or erasable, electrically programmable read only memories (EEPROMs), recordable type mediums such as floppy disks, hard disk drives, and read/write (R/W) compact disc read only memories (CD-ROMs) or digital versatile discs (DVDs), and transmission type mediums such as digital and analog communications links.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. For use in a wireless communications system, a mobile switching center comprising:
a controller which, in response to receiving a clear request triggered by a mobile station terminating call connections while a call involving the mobile station is holding following a call waiting notification to the mobile station, transmits a message to a base station serving the mobile station to maintain resource allocations designated for the mobile station and alert the mobile station of the holding call.

2. The mobile switching center according to claim 1, wherein the message is a clear reject message defined to prompt maintenance of the resource allocations designated for the mobile station and transmission of an alert to the mobile station of the holding call.

3. The mobile switching center according to claim 1, wherein the message is a clear command message with a cause value defined to prompt maintenance of the resource allocations designated for the mobile station and transmission of an alert to the mobile station of the holding call.

4. The mobile switching center according to claim 1, wherein, after transmitting the message, the controller awaits a connect message indicating that the mobile station has initiated connection to the holding call.

5. For use in a wireless communications system, a base station comprising:
a controller which, in response to receiving a clearing procedure message from a mobile switching center triggered by a mobile station which is served by the base station terminating call connections while a call involving the mobile station is holding following a call waiting notification to the mobile station, maintains resource allocations designated for the mobile station and alerts the mobile station of the holding call.

6. The base station according to claim 5, wherein the clearing procedure message is a clear reject message defined to prompt maintenance of the resource allocations designated for the mobile station and transmission of an alert to the mobile station of the holding call.

7. The base station according to claim 5, wherein the clearing procedure message is a clear command message with a cause value defined to prompt maintenance of the resource allocations designated for the mobile station and transmission of an alert to the mobile station of the holding call.

8. The base station according to claim 5, wherein, after alerting the mobile station of the holding call, the controller awaits a connect order from the mobile station requesting connection of the mobile station to the holding call.

9. A wireless communications system, comprising:
a base station serving a mobile station terminating call connections while a call involving the mobile station is holding following a call waiting notification to the mobile station; and
a mobile switching center coupled to the base station,
wherein the mobile switching center, in response to receiving a clear request to clear resource allocations designated for the mobile station, transmits a message to the base station to maintain the resource allocations designated for the mobile station and alert the mobile station of the holding call.

10. The wireless communications system according to claim 9, wherein the message is a clear reject message defined to prompt maintenance of the resource allocations designated for the mobile station and transmission of an alert to the mobile station of the holding call.

11. The wireless communications system according to claim 9, wherein the message is a clear command message with a cause value defined to prompt maintenance of the resource allocations designated for the mobile station and transmission of an alert to the mobile station of the holding call.

12. The wireless communications system according to claim 9, wherein a timer having a default value of 1.5 seconds is started by the clear request and stopped by the message.

13. The wireless communications system according to claim 9, wherein a timer having a default value of 30 seconds is started by the message and stopped by a connect message indicating that the mobile station has initiated connection to the holding call.

14. The wireless communications system according to claim 9, wherein the base station, upon receiving the message, transmits an alert with information to the mobile station to alert the mobile station of the holding call.

15. The wireless communications system according to claim 14, wherein the base station, in transmitting the alert with information to the mobile station, causes a ring tone to sound at the mobile station.

16. The wireless communications system according to claim 14, wherein the base station, after transmitting the alert with information to the mobile station, awaits an acknowledgment of the alert with information from the mobile station.

17. The wireless communications system according to claim 14, wherein the base station, after transmitting the alert with information to the mobile station, awaits a connect order from the mobile station requesting connection to the holding call and, upon receiving the connect order, transmits a connect message to the mobile switching center.

18. A method of wireless communications, comprising:
receiving a release order at a base station serving a mobile station requesting termination of call connections to the mobile station while a call involving the mobile station is holding following a call waiting notification to the mobile station; and
responsive to receiving a clear request triggered by the release order at a mobile switching center coupled to the base station, transmitting a message to the base station to maintain the resource allocations designated for the mobile station and alert the mobile station of the holding call.

19. The method according to claim 18, wherein the step of transmitting a message to the base station to maintain the resource allocations designated for the mobile station and alert the mobile station of the holding call further comprises:
transmitting a clear reject message defined to prompt maintenance of the resource allocations designated for the mobile station and transmission of an alert to the mobile station of the holding call.

20. The method according to claim 18, wherein the step of transmitting a message to the base station to maintain the resource allocations designated for the mobile station and alert the mobile station of the holding call further comprises:
transmitting a clear command message with a cause value defined to prompt maintenance of the resource allocations designated for the mobile station and transmission of an alert to the mobile station of the holding call.

21. The method according to claim 18, further comprising:
starting a timer for the base station having a default value of 1.5 seconds in response to transmitting the clear request;
stopping the timer for the base station in response to receiving the message;
starting a timer for the mobile switching center having a default value of 30 seconds in response to transmitting the message; and
stopping the timer for the mobile switching center in response to receiving a connect message indicating that the mobile station has initiated connection to the holding call.

22. The method according to claim 18, further comprising:
responsive to receiving the message at the base station, transmitting an alert with information to the mobile station to alert the mobile station of the holding call and to cause a ring tone to sound at the mobile station.

23. The method according to claim 18, further comprising:
after transmitting the alert with information to the mobile station, awaiting an acknowledgment of the alert with information from the mobile station and a connect order from the mobile station requesting connection to the holding call; and
upon receiving the connect order, transmitting a connect message to the mobile switching center.
